(19) United States
(12) Patent Application Publication
(10) Pub. No.: US 2005/0050212 A1
(43) Pub. Date: Mar. 3, 2005

(54) Methods and apparatus for access control

(75) Inventors: W. Nathaniel Mills III, Coventry, CT (US); Joseph L. Hellerstein, Ossining, NY (US)

Correspondence Address: Ryan, Mason & Lewis, LLP, 90 Forest Avenue, Locust Valley, NY, 11560, US

(73) Assignee: International Business Machines Corporation, Armonk, NY (US)

(21) Appl. No.: 10/652,526

(22) Filed: Aug. 29, 2003

(51) Int. Cl. G06F 15/16

(52) U.S. Cl. 709/229; 709/219

(57) ABSTRACT

Techniques for flexible and efficient access control are provided. For example, in one aspect of the invention, a technique for processing a request, for access to one or more services, sent from a first computing system to a second computing system, comprises the following steps/operations. A determination is made as to whether the request sent from the first computing system to the second computing system should be deferred. Then, the request is redirected when a determination is made that the request should be deferred, such that access to the one or more services is delayed.

### FIELD OF THE INVENTION

The present invention generally relates to distributed computing networks and, more particularly, to techniques for controlling access to information for transactions associated with a distributed application for use in quality of service management and/or to provide differentiated service.

### BACKGROUND OF THE INVENTION

Electronic businesses are typically operated by companies or service providers in accordance with one or more applications executed in accordance with one or more servers that are part of a distributed network infrastructure such as the World Wide Web (WWW) or the Internet. Such electronic businesses can also operate in accordance with wireless networks. A customer may utilize the services provided by the business by accessing and interacting with the one or more applications hosted by the one or more servers via a client device (or more simply referred to as a client).

Providing differentiated service is critical to running electronic businesses. A key consideration is enforcing service differentiations, e.g., high, medium and low service quality. Service differentiation should be accomplished in a manner that is efficient for the service provider and not overly offensive to customers receiving lower service quality.

Unfortunately, existing access control techniques require their own special communications protocol conventions and/or are not capable of being made transparent to the requesting client.

Thus, a need exists for access control techniques which overcome the above, as well as other, limitations associated with existing access control techniques.

### SUMMARY OF THE INVENTION

The present invention provides techniques for flexible and efficient access control. For example, in one aspect of the invention, a technique for processing a request, for access to one or more services, sent from a first computing system (e.g., a client device) to a second computing system (e.g., a web server), comprises the following steps/operations. A determination is made as to whether the request sent from the first computing system to the second computing system should be deferred. Then, the request is redirected when a determination-is made that the request should be deferred, such that access to the one or more services is delayed.

Further, the determining step/operation and/or the redirecting step/operation may be performed in accordance with a status monitor associated with the second computing system. The determining step/operation may be based on an attribute of the request, content of the request and/or one or more access control policies.

Still further, in accordance with the redirecting step/operation, delayed access to the one or more services may be substantially due to one or more of: (i) network latency; (ii) network processing; (iii) processing by the first computing system; and (iv) establishment of a new connection. The redirecting step/operation may further comprise embedding information in a reply sent from the second computing system to the first computing system. The embedded information may comprise information relating to one or more access control policies. The redirecting step/operation may further comprise redirecting the first computing system to a third computing system.

In another aspect of the invention, a status monitor, associated with the second computing system, is operative to determine whether the request sent from the first computing system to the second computing system should be deferred, and cause redirection of the request when a determination is made that the request should be deferred, such that access to the one or more services is delayed. The status monitor may be resident on the second computing system.

In an illustrative embodiment, the first computing system and the second computing system are able to communicate via the secure HyperText Transport Protocol (HTTP/S).

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a diagram illustrating use of the present invention in a client/server application embodiment;

FIG. 2 is a diagram illustrating creation of time durations to defer client requests based on access control policies, according to a client/server application embodiment of the present invention; and

FIG. 3 is a diagram illustrating an illustrative hardware implementation of a computing system in accordance with which one or more components/methodologies of the present invention may be implemented, according to an embodiment of the present invention.

### DETAILED DESCRIPTION OF THE PREFERRED EMBODIMENTS

The present invention will be explained below in the context of the World Wide Web (WWW) as an illustrative distributed computing network, and in the context of the secure HyperText Transport Protocol (HTTP/S) as an illustrative communications protocol. HTTP/S is defined by Request For Comments (RFCs) 2660, 2617, 2616, 2396, 2246, 2098 and 1945, the disclosures of which are incorporated by reference herein. However, it is to be understood that the present invention is not limited to any particular computing network or any particular communications protocol. Rather, the invention is more generally applicable to any environment in which it is desirable to have flexible and efficient access control. Thus, the present invention may be used in a distributed application comprising at least two application components separated and interacting via some form of communication. For example, while the form of communication illustratively described below includes a network such as the Internet, the form of communication may alternatively be interprocess communication on a platform. One skilled in the art will realize various other scenarios given the inventive teachings disclosed herein.

Further, the phrase “access to one or more services” as referred to herein is intended to broadly include access to any information, any function, any process, any transaction, etc., that one entity (e.g., a client) may desire and/or require, as may be provided by another entity (e.g., a service provider).

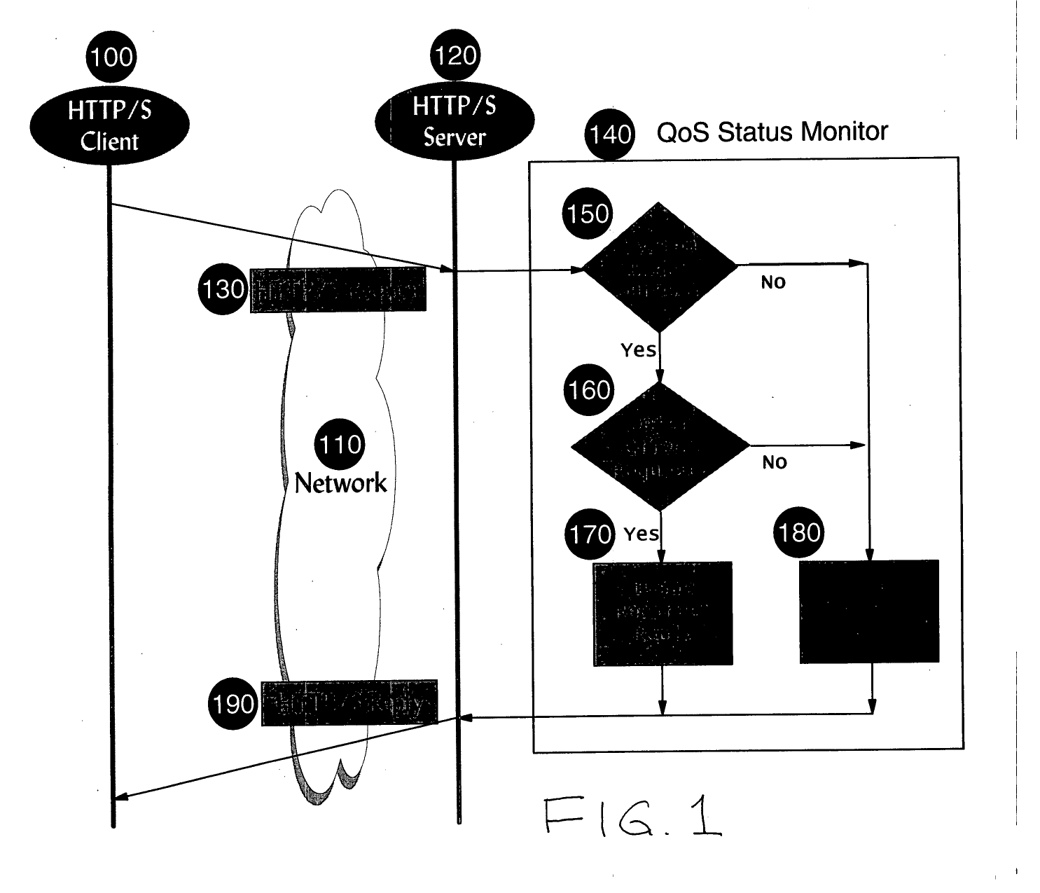

Referring initially to FIG. 1, a diagram illustrates the present invention in a client/server application embodiment. For an illustrative embodiment, assume the network is the Internet or Intranet 110 and the application components are an application component running on an HTTP/S client 100 and an application component running on an HTTP/S server 120. Also, in an illustrative embodiment, assume the protocol is HTTP/S, the client application component runs in accordance with a web browser (e.g., Netscape, Internet Explorer), and the server application component runs on a web server (e.g., IBM Apache, IIS (Internet Information Server from Microsoft), IHS (IBM HTTP Server)). As will be explained below, HTTP/S enables server redirection and an ability to embed information that appears in subsequent requests.

The HTTP/S client 100 communicates across network 110 with an HTTP/S server 120 by issuing an HTTP/S request 130. The HTTP/S server employs a Quality of Service (QoS) status monitor 140 that is aware of the performance and access control policies of the HTTP/S server and can determine if the system is under duress and/or that the system is employing such access control policies (block 150).

By way of example, a web server might be considered to be under duress if it is nearing processing capacity and is taking longer than desired to perform its services. Consider web servers processing stock quotations on a particularly volatile day on the stock market, or a news site during a terrorist attack. The increased traffic would place the server under duress. Of course, other situations like failing hardware or software errors or normal business activities that are not well orchestrated (like performing a bulk data transfer or backup on the system during business hours) can also place a system under duress.

Also, by way of example, access control policies may be employed in the following manner. There may be different classes of customers who subscribe to services at different rates to ensure certain levels of service. A “platinum” customer may pay a premium to get good response time, whereas a “bronze” customer may not pay for this level of service, but is still able to request services as needed. In cases where services are limited (e.g., due to system duress), access control policies may be instituted to allow the customers expected to receive the best level of service to gain access ahead of (more easily than) the customers who have not paid for this privilege. Note that access control policies are not always tied to direct monetary offerings. It may be the business wants to cater to select types of customers and has separated one group of customers from others, wishing to allow better quality of service to some over others. Access control policies may be used to alter the service provided (e.g., return only textual information rather than “heavier” web pages that contain graphs or images), or they may be dynamic, allowing a customer who has limited services to temporarily gain higher access control based on having endured the limited services for a period of time.

If it is determined that the system is under duress and/or is employing access control policies, the QoS status monitor examines the request and determines the level of service appropriate for the request and whether or not the request should be deferred (block 160). For example, requests for service may be classified by the type of business service requested. That is, buying or selling stock may take the highest priority over reviewing one's portfolio, or researching a company. The classification is typically tied to the business model and, in times of system duress, you want the basic business transactions to continue to function at the expense of peripheral transactions. Thus, the status monitor examines the request and makes a determination based on such classifications. This may also include examining the content of the request and/or identifying the requestor. By way of example, this may be accomplished in the following manner. The HTTP request may contain a cookie or Uniform Resource Identifier (URI) parameter that identifies the customer. This may be used along with other attributes of the request (e.g., type of application service requested) by the access control policies to determine how the request will be dealt with.

If the request is to be deferred (i.e., access is being controlled), a redirection message is constructed based on the original HTTP/S request (block 170) content and is returned as the HTTP/S reply (block 190) to the HTTP/S client. If it is determined the system is not under duress and/or is not employing access control policies, or it is determined that there is no need to defer the request or the client, the HTTP/S server continues processing in a normal manner (block 180) to service the request, and responds with the appropriate HTTP/S reply (block 190).

By way of example, in the context of HTTP requests/replies, the request for a given HyperText Markup Language (HTML) page or its content pieces would normally result in a reply carrying the page content or the image, JavaScript, cascading style sheet, etc. Normal replies are returned with a 200 status code. The difference between the normal reply and a redirection reply is the server must retrieve and/or generate the normal reply content, whereas the redirection can be processed quickly with typically much fewer bytes sent in the reply to the requestor. Consider a request carrying search criteria. The server would need to perform the search through its database, compose the response page and return it. However, if instead of this normal reply, the server redirected the request, it merely generates the redirection URL (Uniform Resource Locator) and returns only the HTTP header with the redirection status code 301.

The following is an illustrative sample redirection reply from an IBM web server when a client attempts to request the URL: http://www.ibm.com, which redirects the client to the URL: http://www.ibm.com/us/

<!DOCTYPE HTML PUBLIC “-//IETF//DTD HTML 2.0//EN”>
<HTML><HEAD>
<TITLE>302 Found</TITLE>
</HEAD><BODY>
<H1>Found</H1>
The document has
moved <A HREF=“http://www.ibm.com/us/”>here</A>.<P>
</BODY></HTML>

Thus, redirected requests are processed by the HTTP/S server 120 in an efficient manner, relieving the server of further work to service the request. Only the redirection reply needs to be generated. This saves the server processor from retrieving or possibly manufacturing the content being requested, and from sending this information. Thus, the server conserves processing bandwidth that can be applied to other incoming client requests that pass the access control policy tests.

It is to be understood that the redirection target may be the server receiving the original request or a different server. Redirection to the same server is based on the assumption that the duress condition is transient and the delay incurred in the processing the redirection may help offload enough requests for the server to deal with its backlog and relieve its troubled state. It may also be the situation that only one server (or cluster of servers) can provide the services needed to satisfy the request, so the original requests must be redirected back to the same server for future processing.

An advantageous feature of the present invention is its flexibility in determining how requests are to be handled. Some customers might be redirected to a web page on another server stating “the application is currently busy and to try again later.” While other customers with a different class of service may be allowed to have their requests satisfied. A variation is to have an alternative server providing limited services to customers who are not expected to get the premium quality of service.

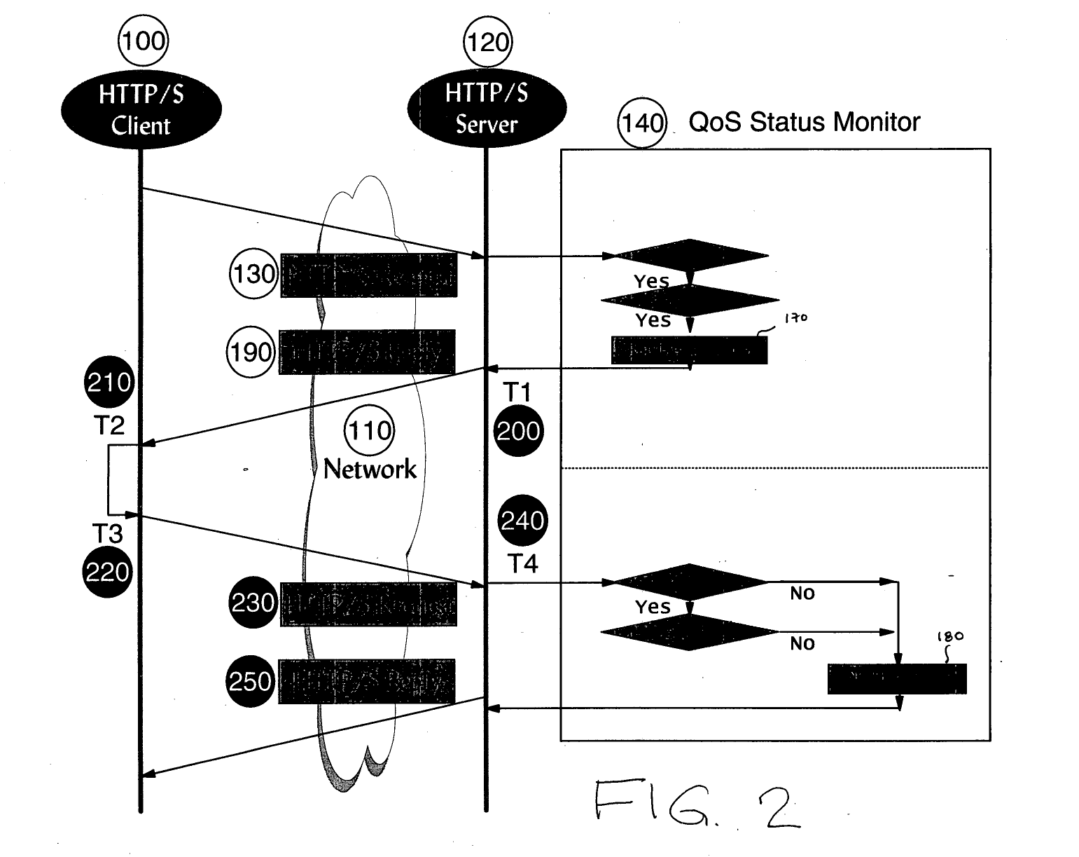

Referring now to FIG. 2, a diagram illustrates time durations created by the present invention to defer client requests based on access control policies. When the redirection HTTP/S reply (block 190) is issued, natural delays are introduced as the reply traverses network 110 due to network latency and processing. This delay is described as the duration of time between T2 (210) and T1 (200).

Further delay is incurred by the HTTP/S client as the client will automatically parse the HTTP/S reply and learn that it must create a new HTTP/S request (block 230) and send the request to the HTTP/S server indicated in the HTTP/S reply. This delay is shown as the duration of time between T3 (220) and T2 (210).

Another delay is introduced while this new HTTP/S request (block 230) traverses the network to the HTTP/S server defined in the previous HTTP/S reply (block 190). This delay is described as the duration of time between T4 (240) and T3 (220). This process can be repeated as many times as QoS status monitor 140 deems is necessary to execute its access policies, e.g., based on service differentiation criteria.

Once the QoS status monitor determines there is no longer a need to defer the request of the client, the QoS status monitor processes the request in the normal fashion and issues the normal reply (block 180) which is returned to the HTTP/S client in an HTTP/S reply (block 250). This concludes the transaction initiated by the HTTP/S client with its original HTTP/S request (block 130).

Advantageously, the present invention may use natural delays occurring off of the server to enable the server to service the appropriate client requests as determined by access control policies of the server. The invention differs from Transmission Control Protocol/Internet Protocol (TCP/IP) based access control methodologies, that operate by temporarily rejecting connection requests, since the invention works on any HTTP/S request and is able to obtain more information about the client and the request carried in this message. When clients request information from servers they must first establish a connection. This connection may be reused for subsequent requests provided both the client and server agree to this convention.

Connection-based access control methodologies only help to control these incoming connection requests, and can not provide access control for clients reusing these connections. The invention has the ability to examine individual requests to obtain the client identity and/or status of previous access control redirections, and make more informed decisions whether or not to admit the request for further processing. Thus, the invention provides content-based access control, i.e., the content of a request may be examined to make the access control decision. The HTTP/S protocol redirection provides a mechanism for the server to communicate to the client where they should go to reissue their request as well as how this new request should be made. This is done by supplying a new URL that the client will use for the subsequent request.

The invention can embed information relating to the access control policy in this URL so when the request is reissued by the client, the access control policy can interpret the additional information to make decisions about access. An example would be to embed the count of the number of attempts to make the request and increase the priority of the request for access.

The invention also differs from connection-based access control methodologies as it can use redirection to cause the client to issue its subsequent HTTP/S request to a completely different server for processing. Furthermore, the system may employ all the other HTTP/S protocol control facilities enabling the server to add additional delays before the client can reissue its request. An example would be to add the “Connection: close pragma” to the HTTP/S reply, informing the client that the connection they are currently using will be abandoned (closed) by the server, thereby forcing the client to establish a new connection. This incurs three network latency delays based on the TCP/IP protocol to form the new connection.

Another advantage of the invention is its apparent transparency to the customer interacting with the HTTP/S client. Unless specifically configured to alert the customer when redirection is occurring, the HTTP/S protocol handler in these clients will automatically process redirections. Since redirection is a common occurrence in the Internet for content management purposes, the majority of users have disabled notification of redirection. While the customer will experience delays in information retrieval, it will not be apparent that this is due to access control policies set by the HTTP/S server.

Furthermore, while the invention does introduce slightly higher amounts of traffic through the network (which, depending on the network, will likely have ample bandwidth with which to absorb the extra traffic), the invention does not introduce excessive processing requirements on either the client or server. Thus, the invention is not deemed to be a computationally intensive or expensive methodology to deploy.

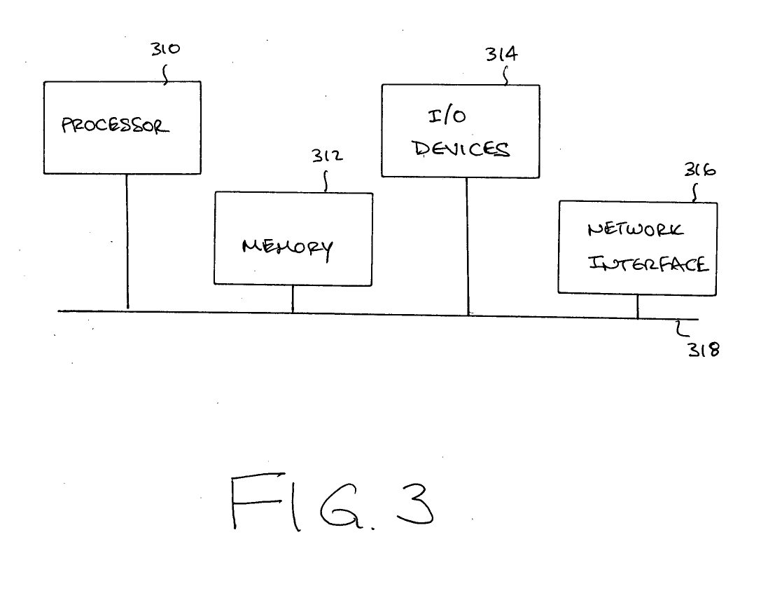

Referring finally to FIG. 3, a block diagram illustrates an illustrative hardware implementation of a computing system in accordance with which one or more components/methodologies of the present invention (e.g., components/methodologies described in the context of FIGS. 1 through 2) may be implemented, according to an embodiment of the present invention. For instance, such a computing system in FIG. 3 may implement the HTTP/S client 100, the HTTP/S server 120 or the QoS status monitor 140.

It is to be understood that such individual components/methodologies may be implemented on one such computer system, or on more than one such computer system. For instance, the client 100 may be implemented on one computer system (e.g., client device), while the server and status monitor may be implemented on another computer system. Of course, the server and status monitor may reside on separate computer systems. In the case of an implementation in a distributed computing system, the individual computer systems and/or devices may be connected via a suitable network, e.g., the Internet or World Wide Web. However, the system may be realized via private or local networks. The invention is not limited to any particular network.

As shown, the computer system may be implemented in accordance with a processor 310, a memory 312, I/O devices 314, and a network interface 316, coupled via a computer bus 318 or alternate connection arrangement.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc.

In addition, the phrase “input/output devices” or “I/O devices” as used herein is intended to include, for example, one or more input devices (e.g., keyboard, mouse, etc.) for entering data to the processing unit, and/or one or more output devices (e.g., speaker, display, etc.) for presenting results associated with the processing unit.

Still further, the phrase “network interface” as used herein is intended to include, for example, one or more transceivers to permit the computer system to communicate with another computer system via an appropriate communications protocol (e.g., HTTP/S).

Accordingly, software components including instructions or code for performing the methodologies described herein may be stored in one or more of the associated memory devices (e.g., ROM, fixed or removable memory) and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

1. A method of processing a request, for access to one or more services, sent from a first computing system to a second computing system, the method comprising the steps of:
determining whether the request sent from the first computing system to the second computing system should be deferred; and
redirecting the request when a determination is made that the request should be deferred, such that access to the one or more services is delayed.

2. The method of claim 1, wherein at least one of the determining and redirecting steps are performed in accordance with a status monitor associated with the second computing system.

3. The method of claim 1, wherein the determining step is based on one or more of: (i) an attribute of the request; and (ii) content of the request.

4. The method of claim 1, wherein the determining step is based on one or more access control policies.

5. The method of claim 1, wherein, in accordance with the redirecting step, delayed access to the one or more services may be substantially due to one or more of: (i) network latency; (ii) network processing; (iii) processing by the first computing system; and (iv) establishment of a new connection.

6. The method of claim 1, wherein the redirecting step further comprises the step of embedding information in a reply sent from the second computing system to the first computing system.

7. The method of claim 6, wherein the embedded information comprises information relating to one or more access control policies.

8. The method of claim 1, wherein the first computing system and the second computing system are able to communicate via the secure HyperText Transport Protocol.

9. The method of claim 1, wherein the redirecting step further comprises redirecting the first computing system to a third computing system.

10. Apparatus for processing a request, for access to one or more services, sent from a first computing system to a second computing system, the apparatus comprising:
a memory; and
at least one processor coupled to the memory and operative to: (i) determine whether the request sent from the first computing system to the second computing system should be deferred, and (ii) cause redirection of the request when a determination is made that the request should be deferred, such that access to the one or more services is delayed.

11. The apparatus of claim 10, wherein the determining operation is based on one or more of: (i) an attribute of the request; and (ii) content of the request.

12. The apparatus of claim 10, wherein the determining operation is based on one or more access control policies.

13. The apparatus of claim 10, wherein, in accordance with the redirecting operation, delayed access to the one or more services may be substantially due to one or more of: (i) network latency; (ii) network processing; (iii) processing by the first computing system; and (iv) establishment of a new connection.

14. The apparatus of claim 10, wherein the redirecting operation further comprises causing the embedding of information in a reply sent from the second computing system to the first computing system.

15. The apparatus of claim 14, wherein the embedded information comprises information relating to one or more access control policies.

16. The apparatus of claim 10, wherein the first computing system and the second computing system are able to communicate via the secure HyperText Transport Protocol.

17. The apparatus of claim 10, wherein the redirecting operation further comprises redirecting the first computing system to a third computing system.

18. An article of manufacture for processing a request, for access to one or more services, sent from a first computing system to a second computing system, comprising a machine readable medium containing one or more programs which when executed implement the steps of:
determining whether the request sent from the first computing system to the second computing system should be deferred; and
causing redirection of the request when a determination is made that the request should be deferred, such that access to the one or more services is delayed.

19. Apparatus for processing a request, for access to one or more services, sent from a first computing system to a second computing system, the apparatus comprising:
a status monitor, associated with the second computing system, operative to: (i) determine whether the request sent from the first computing system to the second computing system should be deferred, and (ii) cause redirection of the request when a determination is made that the request should be deferred, such that access to the one or more services is delayed.

20. The apparatus of claim 19, wherein the status monitor is resident on the second computing system.
